(19) United States
(12) Patent Application Publication
(10) Pub. No.: US 2024/0256321 A1
(43) Pub. Date: Aug. 1, 2024

(54) DYNAMICALLY PROVISIONING A CUSTOM STACK

(71) Applicant: Dell Products L.P., Round Rock, TX (US)

(72) Inventors: Muzhar S. KHOKHAR, Shrewsbury, MA (US); XiaoJun WU, Shanghai (CN); Haijun ZHONG, Shanghai (CN); Qing LI, Shanghai (CN); Deborah C. RUSSELL, Arvada, CO (US)

(73) Assignee: Dell Products L.P., Round Rock, TX (US)

(21) Appl. No.: 18/161,748

(22) Filed: Jan. 30, 2023

(51) Int. Cl. G06F 9/455; G06F 3/06

(52) U.S. Cl. CPC G06F 9/45558; G06F 3/0671; G06F 2009/45575

(57) ABSTRACT

An information handling system may include at least one processor and a memory. The information handling system may be configured to: boot a first operating system, wherein the first operating system is configured to automatically execute a provision service; read, by the provision service, a file indicating a desired stack for the information handling system, wherein the desired stack specifies components including at least one second operating system, at least one firmware, at least one driver, and at least one software application; install, by the provision service, the components specified by the desired stack; and boot the second operating system.

### TECHNICAL FIELD

The present disclosure relates in general to information handling systems, and more particularly to techniques for provisioning software onto bare-metal information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any executable instructions, or aggregation of program of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

When a new HCI system is built for a customer, it is typically provisioned with a set of components referred to herein as a “stack.” A stack may include an operating system, hypervisor, firmware, drivers, software, etc.

However, there are many potential stacks that a system might need, and there may be considerable differences among them depending on the intended use case for the system (e.g., private cloud, public cloud, edge computing, etc.). For example, even among cloud-native HCI systems using Kubernetes for orchestration, there are many possible choices for OSes, container runtimes, service orchestration applications, and other microservices. An administrator may select different software combinations based on the specific requirements for the system.

Accordingly, it can be difficult or impossible to pre-define the stack at the factory given the large number of options and potential use cases. Embodiments of this disclosure allow a system manufacturer to provide a customer with the ability to provision a bare metal server to the desired stack automatically and efficiently. It should be noted that the term “factory” is used herein, and it may refer generally to an environment in which an information handling system is manufactured and/or assembled and/or set up by a manufacturer, retailer, wholesaler, etc.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with provisioning of information handling systems may be reduced or eliminated.

In accordance with embodiments of the present disclosure, an information handling system may include at least one processor and a memory. The information handling system may be configured to: boot a first operating system, wherein the first operating system is configured to automatically execute a provision service; read, by the provision service, a file indicating a desired stack for the information handling system, wherein the desired stack specifies components including at least one second operating system, at least one firmware, at least one driver, and at least one software application; install, by the provision service, the components specified by the desired stack; and boot the second operating system.

In accordance with these and other embodiments of the present disclosure, a method may include an information handling system booting a first operating system, wherein the first operating system automatically executes a provision service; reading, by the provision service, a file indicating a desired stack for the information handling system, wherein the desired stack specifies components including at least one second operating system, at least one firmware, at least one driver, and at least one software application; installing, by the provision service, the components specified by the desired stack; and the information handling system booting the second operating system.

In accordance with these and other embodiments of the present disclosure, an article of manufacture may include a non-transitory, computer-readable medium having computer-executable instructions thereon that are executable by a processor of an information handling system cluster for: booting a first operating system, wherein the first operating system automatically executes a provision service; reading, by the provision service, a file indicating a desired stack for the information handling system, wherein the desired stack specifies components including at least one second operating system, at least one firmware, at least one driver, and at least one software application; installing, by the provision service, the components specified by the desired stack; and booting the second operating system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIGS. 2-3 illustrate example methods, in accordance with embodiments of the present disclosure.

### DETAILED DESCRIPTION

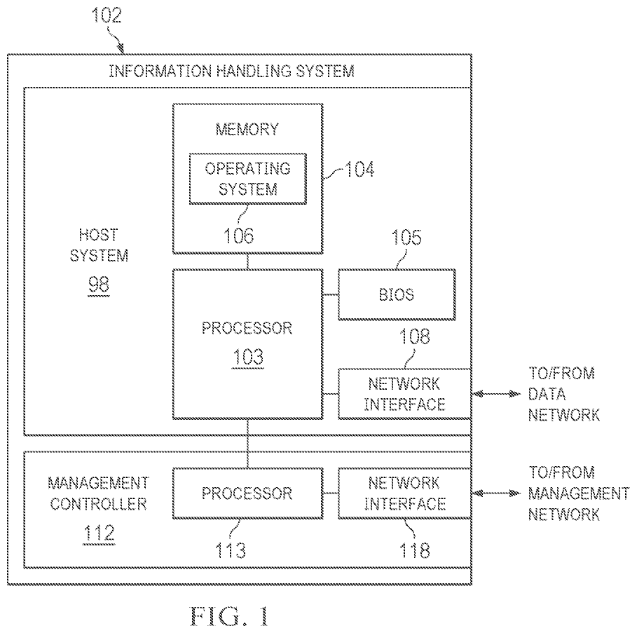

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and management a controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface network 108 (e.g., interface for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the provisioning of information handling systems 102 with a desired stack. It should be noted that while the scenario of an information handling cluster such as an HCI system is discussed in detail herein for the sake of concreteness, other embodiments are also specifically contemplated within the scope of this disclosure.

In one embodiment, a provision service may be installed on a newly manufactured information handling system at the factory. The provision service may be based on a small bootable operating system (e.g., Linux) and may further include a program that is executable by the bootable operating system for custom-defined stack provisioning. The provision service may be installed on the system's hard disk or any other bootable storage medium, and it may provide the capability of provisioning the bare-metal server based on a stack definition provided by the user.

In one embodiment, the small bootable operating system that runs the provision service may be installed on a first storage medium, and the stack may be provisioned onto a second storage medium. The provision service may then adjust a BIOS setting so that the system subsequently boots from the second storage medium.

A template of the system's stack may be defined which may include information regarding desired firmware versions, operating system (s), drivers, and other software. An administrator may define a custom configuration based on the template to describe the desired stack of server. In this disclosure, such a definition is referred to as a Provision Input File (PIF). The PIF can be read by the provision service to provision the server to the desired stack. Thus an administrator may provision servers for an HCI cluster with a custom stack by defining a PIF before the server is even shipped to the site. When the server arrives and is powered on, the provision service may automatically provision the server with the desired stack, allowing the system to reach a usable state in a matter of hours rather than days.

Any suitable data format may be used for the PIF. For example, XML, JSON, a key-value store, or any other desired format may be used in various embodiments. For the sake of concreteness, a basic example PIF is provided below at Listing 1. Listing 1 includes a few elements of example data, but one of ordinary skill in the art will appreciate that other elements may also be present in various implementations.

Listing 1.

| version: v1 | |
|---|---|
| bmc: | |
| type: idrac | |
| ip: xxx.xxx.xxx.xxx | |
| username: ******** | |
| password: ******** | |
| sn: | |
| type: PSNT | |
| sn: xxxx | |
| firmware: | |
| version: 1.0.0 | |
| url: http://... or file: //... | |
| os: | |
| name: SLES | |
| type: cloud_image/win | |
| description: | |
| url: http://xxx | |
| config: | |
| hostname: xxx | |
| user: #follow cloud-init | |
| network: #follow cloud-init config v2 | |
| disk: #follow cloud-init | |
| device aliases: | |
| disk_setup: | |
| fs_setup: | |
| packages: | |
| - | name: docker |
| | version: 1.0.0 |
| | description: |
| | install_cmd: apt-get install docker=20.10.6 |
| | uninstall_cmd: apt-get remove docker |
| - | name: kubernetes |
| | version: 1.0.0 |
| | install_cmd: |

```
      url: http://test.local/k8s.sh
      params:
        - --join-after-install=1.1.1.1/<...token...>
    uninstall_cmd:
      url: http://test.local/remove_k8s.sh
```

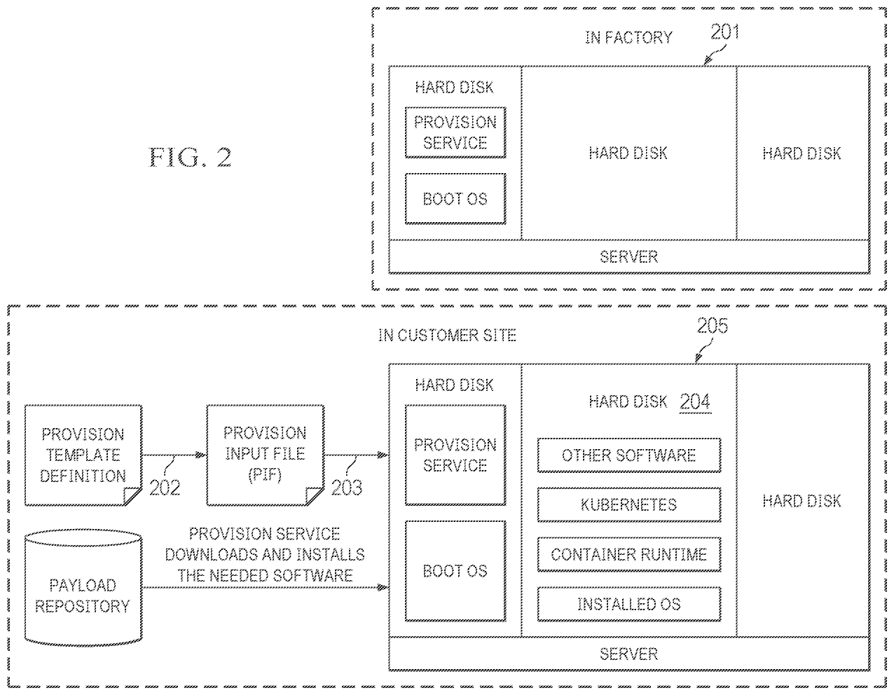

Turning now to FIG. 2, an example method is shown for provisioning an information handling system as a Kubernetes work node, according to some embodiments.

As shown at step 201, in the factory environment, the provision service is installed to the hard disk, including a boot OS. The server may also be configured to boot from that disk (e.g., by changing a BIOS setting or the like).

At step 202, an administrator at the customer site may create a PIF to define the desired stack for the server. For example, this desired stack may be defined based on the administrator's existing environment (e.g., a cloud-native platform in this example). In many cases, the same operating system, container runtime, and orchestrator will be used for all nodes within the cluster, and so a default PIF may be generated based on (or retrieved from) one of the existing systems.

At step 203, the server may be plugged in and started up at the customer site. It may retrieve the PIF (e.g., from a predefined network location, from a removable storage medium, etc.). Based on the stack defined in the PIF, the server may then download the necessary files (e.g., from local network resources or internet resources), install any necessary firmware components, and install the OS.

At step 204, the server may be rebooted and load the newly installed OS. An installation script may be automatically invoked by the OS to continue the setup process. At step 205, the container runtime, Kubernetes, and any other needed services may be downloaded and installed by the installation script. After the completion of step 205, the desired stack is in place and the server is ready to be used.

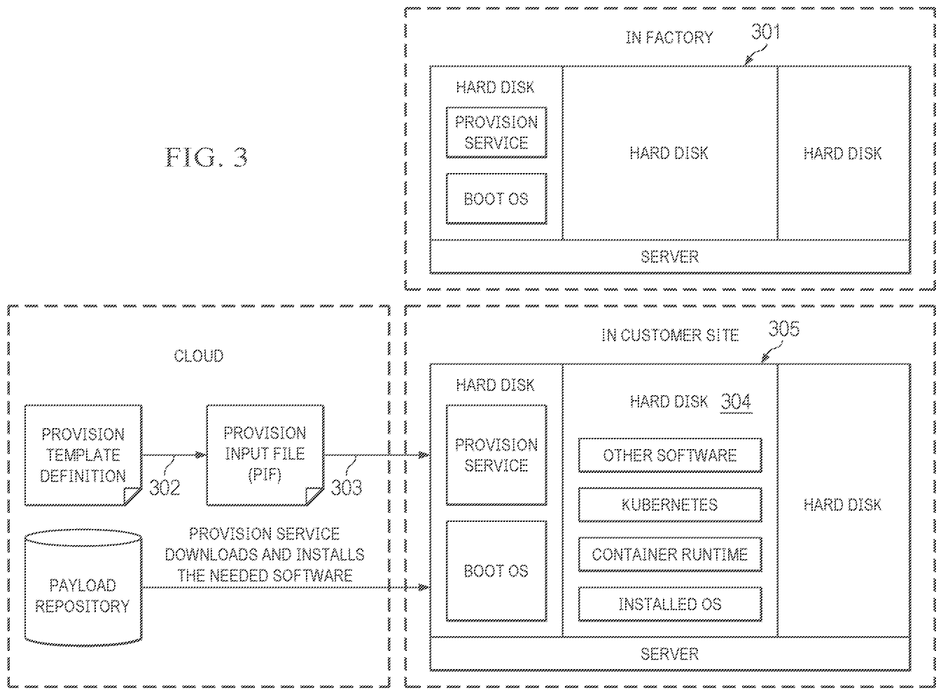

Turning now to FIG. 3, an example method is shown for provisioning an information handling system as an edge gateway, according to some embodiments. The method of FIG. 3 is somewhat similar to the method of FIG. 2, and so corresponding reference numbers are used for corresponding steps.

As shown at step 301, in the factory environment, the provision service is installed to the hard disk, including a boot OS. The server may also be configured to boot from that disk (e.g., by changing a BIOS setting or the like).

At step 302, an administrator at the customer site may create a PIF to define the desired stack for the server. For example, this desired stack may be defined based on the administrator's existing environment (e.g., a cloud-native platform in this example). In many cases, the same operating system, container runtime, and orchestrator will be used for all nodes within the cluster, and so a default PIF may be generated based on (or retrieved from) one of the existing systems. In this example, the PIF may be stored at a cloud location (e.g., a public or private cloud).

At step 303, the server may be plugged in and started up at the customer site. The provision service may then be invoked via the cloud with the PIF. Based on the stack defined in the PIF, the server may then download the necessary files (e.g., from local network resources or internet resources), install any necessary firmware components, and install the OS.

At step 304, the server may be rebooted and load the newly installed OS. An installation script may be automatically invoked by the OS to continue the setup process. At step 305, any upstream software referenced in the PIF may be downloaded and installed by the installation script. After the completion of step 305, the desired stack is in place and the server is ready to be used.

One of ordinary skill in the art with the benefit of this disclosure will that understand the preferred initialization point for the methods depicted in FIGS. 2-3 and the order of the steps comprising the methods may depend on the implementation chosen. In these and other embodiments, the methods may be implemented as hardware, firmware, software, applications, functions, libraries, or other instructions. Further, although FIGS. 2-3 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for a [performing function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
boot a first operating system, wherein the first operating system is configured to automatically execute a provision service;
read, by the provision service, a file indicating a desired stack for the information handling system, wherein the desired stack specifies components including at least one second operating system, at least one firmware, at least one driver, and at least one software application;
install, by the provision service, the components specified by the desired stack; and
boot the second operating system.

2. The information handling system of claim 1, wherein the information handling system is a hyper-converged infrastructure (HCI) system.

3. The information handling system of claim 1, wherein the first operating system and the provision service were installed during a manufacturing process of the information handling system.

4. The information handling system of claim 1, wherein the first operating system resides on a first physical storage resource, and wherein the second operating system resides on a second physical storage resource.

5. The information handling system of claim 4, wherein the provision service is further configured to cause the information handling system to boot from the second physical storage resource.

6. The information handling system of claim 1, wherein the provision service is further configured to retrieve the components specified by the desired stack from a repository.

7. A method comprising:
an information handling system booting a first operating system, wherein the first operating system automatically executes a provision service;
reading, by the provision service, a file indicating a desired stack for the information handling system, wherein the desired stack specifies components including at least one second operating system, at least one firmware, at least one driver, and at least one software application;
installing, by the provision service, the components specified by the desired stack; and
the information handling system booting the second operating system.

8. The method of claim 7, wherein the information handling system is a hyper-converged infrastructure (HCI) system.

9. The method of claim 7, wherein the first operating system and the provision service were installed during a manufacturing process of the information handling system.

10. The method of claim 7, wherein the first operating system resides on a first physical storage resource, and wherein the second operating system resides on a second physical storage resource.

11. The method of claim 10, wherein the provision service is further configured to cause the information handling system to boot from the second physical storage resource.

12. The method of claim 7, wherein the provision service further retrieves the components specified by the desired stack from a repository.

13. An article of manufacture comprising a non-transitory, computer-readable medium having computer-executable instructions thereon that are executable by a processor of an information handling system for:
booting a first operating system, wherein the first operating system automatically executes a provision service;
reading, by the provision service, a file indicating a desired stack for the information handling system, wherein the desired stack specifies components including at least one second operating system, at least one firmware, at least one driver, and at least one software application;
installing, by the provision service, the components specified by the desired stack; and
booting the second operating system.

14. The article of claim 13, wherein the information handling system is a hyper-converged infrastructure (HCI) system.

15. The article of claim 13, wherein the first operating system and the provision service were installed during a manufacturing process of the information handling system.

16. The article of claim 13, wherein the first operating system resides on a first physical storage resource, and wherein the second operating system resides on a second physical storage resource.

17. The article of claim 16, wherein the provision service causes the information handling system to boot from the second physical storage resource.

18. The article of claim 13, wherein the provision service is further configured to retrieve the components specified by the desired stack from a repository.
